(19) United States
(12) Patent Application Publication
(10) Pub. No.: US 2002/0049707 A1
(43) Pub. Date: Apr. 25, 2002

(54) Expanded patent search

(76) Inventor: Norton R. Townsley, Beverly Hills, CA (US)

Correspondence Address: Norton R. Townsley, Suite 330, 100 Corporate Pointe, Culver City, CA, 90230, US

(21) Appl. No.: 09/846,775

(22) Filed: May 1, 2001

Related U.S. Application Data
(60) Provisional application No. 60/202,487, filed on May 8, 2000.

(51) Int. Cl. G06F 7/00

(52) U.S. Cl. 707/1

(57) ABSTRACT

An improvement on current and future methods of patent searching. In this expanded method of patent searching, computer searches are also made in the trademark records of the USPTO, the States and on the Internet for goods and services the same as and similar to the invention of interest.

### CROSS REFERENCE

The applicant claims the benefit of his Provisional Application, Serial No. 60/202,487, filed May 5, 2000.

### BACKGROUND OF THE INVENTION

The present invention relates to the field of patents and more particularly to the field of patent or patentability searching.

A patent or patentability search is typically performed by a professional, such as a patent attorney, prior to writing and submitting a patent application in order to aid the attorney and his client in deciding whether to file a US patent application for a particular invention. To perform a patent search, one strategy is to try to determine the class in which the application would fit and then look through the US patents filed in that class in order to find patents that are the same as or similar to the invention. Another strategy is to search through the titles, abstracts and/or the texts of issued patents for words, that would describe the invention. With pending changes in US patent law, a search will soon have to be made also in published US patent applications. Searches may be performed manually, in the public reading room at the US Patent and Trademark Office (USPTO), at the various depository libraries and electronically via the USPTO web site or other similar databases.

The applicant is a Registered US Patent Attorney in private practice. He routinely commissions patent searches for his clients. Recently, this applicant had the experience of finding an exact match for an applicant's invention in the trademark records of the USPTO. Apparently, someone had invented this invention many years earlier, had never bothered to patent it but had obtained a US trademark registration. In another case a client found a similar invention on the Internet. Again, apparently someone had started to sell the device without seeking US patent protection.

What innovative clients now need is a patent or patentability search that can detect inventions of interest which have never been patented but may show up in trademark registrations and on the Internet. Development of a patent or patentability search that can detect inventions of interest which have never been patented but which may show up in trademark registrations and on the Internet represents a great improvement in the field of patent searching and satisfies a long felt need of inventors and patent professionals.

### SUMMARY OF THE INVENTION

The present invention is an improvement on current and future methods of patent searching. In this expanded method of patent searching computer searches are also made in the trademark records of the USPTO and on the Internet for goods and services the same as and similar to the invention of interest.

An appreciation of the other aims and objectives of the present invention and an understanding of it may be achieved by referring to the following description of a preferred embodiment.

### DETAILED DESCRIPTION OF THE PREFERRED EMBODIMENT

In patent searching, a client provides a description of the invention (the invention of interest), and the searcher attempts to detect patents the same as and similar to this invention. In methods currently used, the searcher may first try to decide in which USPTO classification or classifications the invention of interest would most likely be placed by the USPTO or may first decide on descriptive keywords for the invention. Then the searcher will search for issued patents the same as and similar to the invention of interest in the patent records of the USPTO. The searcher may search through manually in the patent library of the USPTO or may search electronically (i.e. via computer) on a public or private database. A public patent database is available, for example, via the USPTO web site (http://www.uspto.gov). Soon, because of impending changes in US patent law, searches will have to be made in the published patent application records of the USPTO. The term “patent records of the USPTO” as used in the claims of this application is intended to include both issued patents and published patent applications.

This invention is an improvement on current methods of patent searching. In this improved method, the standard method, outlined above, is expanded by additionally making a computer search in the trademark records of the Federal and State Governments and making a computer search on the Internet for goods and services the same as and similar to the invention of interest. The trademark records of the USPTO can be searched directly on the USPTO web site or via a variety of public and private services that are available on the Internet. The trademark records of the States can be searched via a variety of private services that are available on the Internet. In any of these web sites a search for registrations may be made by entering the appropriate key words in the goods and services field of the search engine. The Internet search is similarly made by entering appropriate keywords into one of the many popular search engines such as Yahoo, Lycos and Ask Jeeves. For the purposes of this application the term trademark includes trademarks and service marks.

The expanded method of patent searching has been described with reference to a particular embodiment. Other modifications and enhancements can be made without departing from the spirit and scope of the claims that follow.

What is claimed is:

1. In a method of patent searching of the type in which an attempt is made to detect patents the same as and similar to an invention of interest, an expanded method of patent searching in which the improvement comprises the steps of:
a. making a computer search in the trademark records of the USPTO for goods and services the same as and similar to the invention of interest;
b. making a computer search in the trademark records of the States for goods and services the same as and similar to the invention of interest; and
c. making a computer search on the Internet for goods and services the same as and similar to the invention of interest.

2. A method of patent searching comprising the steps of:
a. making a search in the patent records of the USPTO for patents the same as and similar to an invention of interest;
b. making a computer search in the trademark records of the USPTO for goods and services the same as and similar to said invention of interest;
c. making a computer search in the trademark records of the States for goods and services the same as and similar to said invention of interest; and
d. making a computer search on the Internet for goods and services the same as and similar to said invention of interest.

3. A method as described in claim 2 in which the search in the patent records of the USPTO is made manually.

4. A method as described in claim 2 in which the search in the patent records of the USPTO is made via a computer.

5. A method as described in claim 2 further comprising the step of deciding a classification of said invention of interest and making said search in the patent records of the USPTO in said classification.
